(19) United States
(12) Patent Application Publication
(10) Pub. No.: US 2007/0242653 A1
(43) Pub. Date: Oct. 18, 2007

(54) METHOD AND APPARATUS FOR SHARING RADIO RESOURCES IN AN OFDMA-BASED COMMUNICATION SYSTEM

(75) Inventors: Yunsong Yang, San Diego, CA (US); Anthony C. K. Soong, Plano, TX (US); Jianmin Lu, San Diego, CA (US)

Correspondence Address: AKIN GUMP STRAUSS HAUER & FELD, LLP, P O BOX 688, DALLAS, TX, 75313-0688, US

(73) Assignee: FutureWei Technologies, Inc., Plano, TX (US)

(21) Appl. No.: 11/734,498

(22) Filed: Apr. 12, 2007

Related U.S. Application Data
(60) Provisional application No. 60/791,700, filed on Apr. 13, 2006.
(60) Provisional application No. 60/793,961, filed on Apr. 20, 2006.

(51) Int. Cl. H04B 7/216

(52) U.S. Cl. 370/342

(57) ABSTRACT

A physical layer packet format and signaling method is provided to minimize signaling overhead wherein multiple users share air interface resources to improve efficiency in orthogonal frequency division multiplexing (OFDM) and orthogonal frequency division multiple access (OFDMA) communication systems.

### PRIORITY CLAIM

This application claims the priority benefit of U.S. Provisional Application No. 60/791,700 filed Apr. 13, 2006 and U.S. Provisional Application No. 60/793,961 filed on Apr. 20, 2006.

### TECHNICAL FIELD OF THE INVENTION

The present invention relates generally to sharing radio resources in a wireless communication system and, more particularly, to a system for sharing radio resources among a plurality of users with minimal signal overhead in an OFDMA communication system.

### BACKGROUND OF THE INVENTION

In a wireless multiple access communication system, wireless traffic channel resources (e.g., bandwidth, time intervals) are shared by all wireless users in a particular cell. Efficient allocation of traffic channel resources among various wireless users is critical to ensuring high performance for all such users, as it directly impacts overall utilization of traffic channel resources and quality of service perceived by each wireless user.

One method of providing wireless communication services is using a technique known as Orthogonal Frequency Division Multiplexing (OFDM). Other techniques providing wireless communication among a number of different users include: Time Division Multiplex Access (TDMA), which segments wireless communication resources among various users according to time; and Code Division Multiplex Access (CDMA), which segments wireless communication resources according to spreading codes.

By dividing signal spectrum into a number of equally spaced tones, OFDM carries a portion of user data on each individual tone. Each OFDM tone is commonly referred to as a frequency sub-carrier. A primary advantage of OFDM—over other types of frequency division multiplexing (FDM) techniques—is that each tone is orthogonal to other tones, meaning no two tones will interfere with one another. This allows tones to overlap, thereby increasing the maximum amount of data that can be communicated for a given bandwidth allocation compared to other FDM techniques.

The multiplexed nature of OFDM lends itself to implementation in multiple user access environments since individual tones, or groups of tones, can be assigned to particular users. This allows multiple users to transfer and receive data simultaneously, rather than waiting on an assigned “time slot,” as in TDMA systems. More importantly, users requiring larger shares of bandwidth resources can be assigned multiple frequency subcarriers providing a greater proportion of total available bandwidth. When multiple users share bandwidth in this manner, a system is generally referred to as Orthogonal Frequency Division Multiple Access, or OFDMA.

In OFDMA, each user can be assigned a predetermined number of tones when they have information to send, or alternatively, a user can be assigned a variable number of tones to communicate information. Assignments of tones are generally dictated by the media access control layer, or MAC layer, which is ordinarily responsible for assignment of resources depending on user demand.

Resource allocation from particular base stations may be valid for transmission of a single packet, or for multiple packets. When resources are preferentially allocated for more than a single packet, the preferential resource allocation is commonly referred to as a sticky assignment or persistent assignment. Similarly, allocations terminating after transmission of a single packet are generally referred to as non-sticky or non-persistent assignments. Sticky assignments reduce overhead in allocating resources among various users, resulting in improved performance when particular users need a dedicated allocation of bandwidth.

Although sticky assignments reduce overhead, and increase effective throughput of a system, utilization of system resources in such a manner are not ideal in every circumstance. Frequently, sticky assignments may be set up for to ensure a minimum quality of service for a particular user. Sticky assignments may be used when implementing Voice over Internet Protocol (VoIP) applications. In such cases, a sticky assignment reduces the latency of communications when resources are spread among a large number of users. However, users frequently use less than the full extent of resources allocated to them. For example, in VoIP communications, silence may be transmitted using a far lower data rate than ordinary voice. In these situations, it would be advantageous to maximize utilization of resources allocated by sticky assignment without introducing excessive overhead or substantial complexity.

One method of error control is the Hybrid Automatic-Repeat-reQuest (H-ARQ) method. In H-ARQ implementations, receivers add data packets (that cannot be decoded) into a detection buffer (located at the receiver) whenever received data packets fail a cyclic redundancy check (CRC). In H-ARQ systems, unacknowledged packets are retransmitted, and data stored in detection buffers is used to construct a retransmitted packet. When data from detection buffers is combined with received data, more accurate representations of packets can be assured. In such cases, a subsequent cyclic redundancy check performed on the packet, if passed, verifies accurate construction of the data.

In systems that utilize H-ARQ, it is critical that detection buffers be flushed on a regular basis to maintain good performance. Specifically, corruption of the detection buffer can occur if information intended for one user is mixed with information intended for another user. In systems where each packet is intended for a single user, several implementations allow for flushing of detection buffers when new H-ARQ sequences begins for particular users. It would be advantageous to optimize methods of indicating new H-ARQ sequences in systems utilizing sub-packets where more than one user may try to decode the single packets while only one user is the intended user. In such systems, it would be desirable to indicate new H-ARQ sequences to multiple users so each user can determine if detection buffers should be flushed

### SUMMARY OF THE INVENTION

The present invention provides a system, comprising various methods and apparatus, for a plurality of users to share radio resources otherwise assigned to particular users as sticky assignments. Packet structure is provided for sharing radio resources (e.g., tones or frequency subcarriers) between a plurality of users—particularly tones or frequency subcarriers that have been sticky assigned to a particular user. As disclosed herein, a single packet may be split into a plurality of sub-packets. Methods are also provided for signaling to a plurality of users to share radio resources that have already been assigned, by a sticky assignment, to a particular user. In particular, methods of utilizing H-ARQ error control to facilitate improved communication between the base stations and multiple users are disclosed, especially communication methods for utilizing sub-packets.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow diagram depicting a method of enabling radio resource sharing in an OFDMA system according to certain embodiments of the present invention;

FIG. 2 depicts an example of a resource assignment for a plurality of users;

FIG. 3 depicts an illustrative transmitted sequence in a header segment according to the present invention; and

FIG. 4 depicts another illustrative transmitted sequence in a header segment according to the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

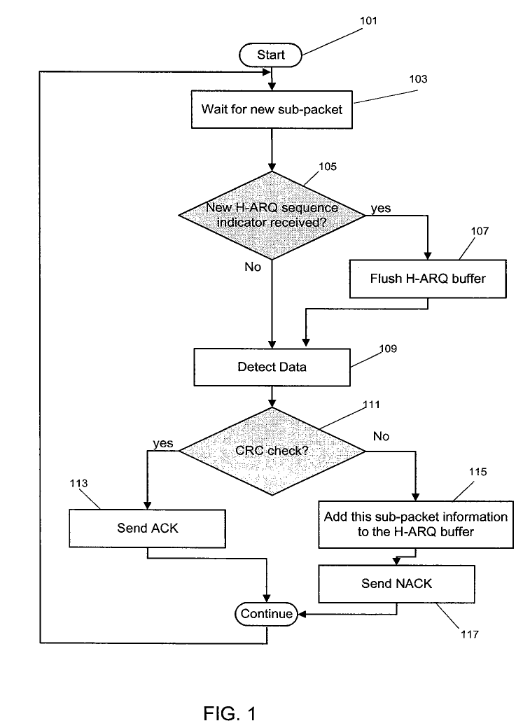

Referring now to FIG. 1, a flow diagram depicts one embodiment of enabling radio resource sharing in an OFDMA system. In the embodiment depicted in FIG. 1, the process of receiving information in the system begins at step 101 for a receiver. At step 103, the receiver waits for a new sub-packet to arrive. After receiving a sub-packet during step 103, the receiver determines if a new H-ARQ sequence indicator is received. A new Hybrid Automatic-Repeat-reQuest (H-ARQ) sequence may be indicated according to the present invention in a number of different ways.

It is contemplated that the intended user of a packet can be signaled in a number of ways, using methods that explicitly and/or implicitly inform the users in a wireless system, including the intended user of the packet, that a particular packet is destined for the intended user. According to certain embodiments of the present invention, a packet structure enables a user to determine if a particular packet, or sub-packet, is intended for that particular user. In accordance with this packet structure, each user in the system is assigned a unique scrambling code. This unique scrambling code can be assigned in a variety of different ways, including methods that utilize the mobile station identifier, MAC address, and other unique identifiers for the particular user. Utilizing this packet structure, a subset of the packet, or sub-packet, may be individually assigned, or allocated, to particular users, with each sub-packet preferably divided between a header section and a data section. In alternative embodiments of the present invention, the sub-packets are not split into header and data sections.

When utilizing scrambling codes to implicitly identify the intended user of a sub-packet, the transmitter scrambles the data section, and optionally header section, of the sub-packet with the unique scrambling code assigned to the intended user. Receiving users can only decode the packet if they have the particular unique scrambling code used to encode the sub-packet, thereby implicitly signaling to the users whether they are the intended users. Alternatively, a packet header or sub-packet header that is unscrambled can be used to explicitly transmit information about the intended user of a packet in other embodiments of the invention.

When a particular scrambled packet is received by a user, the user applies its unique scrambling code to descramble the sub-packet based on the method of scrambling applied in the system. If the packet was scrambled with the unique scrambling code assigned to the particular user, then the descrambled packet is an accurate representation of the original packet, or sub-packet. If the user's scrambling code is different from the scrambling code used to encode the packet, i.e. an unintended user, the resulting descrambled packet will be useless for the unintended user. One method of verifying the success of the descrambling process is by performing a cyclic redundancy checks using values transmitted within the packet itself, in the headers of the packets or sub-packets, or transmitted across an alternative signaling channel. The cyclic redundancy check can provide verification on whether a particular packet is intended for the user by determining if the descrambled packet, or sub-packet, matches the original packet, or sub-packet.

In certain implementations utilizing H-ARQ, a receiver adds received information to a detection buffer, located at the receiver, whenever the cyclic redundancy check (CRC) on the sub-packet or packet fails. As discussed herein, corruption of the detection buffer can occur if the data packet intended for one user is mixed with another data packet for the same user or the data packet intended for another user. To avoid corruption, embodiments of the present invention provide a transmission protocol in a particular H-ARQ interlace, designed such that an H-ARQ sequence at the receiver is completed before a new sequence is commenced, as the beginning of the new H-ARQ sequence is signaled to the receiver.

Receivers, upon receiving notification a new H-ARQ sequence has started, flush the detection buffer at the receiver, as information in the detection buffer will not be useful in reconstructing packets for that particular receiver. In certain embodiments, the new H-ARQ sequence signal is explicitly sent in the header of a packet or sub-packet. In other embodiments, the signal indicating a new H-ARQ sequence is communicated on a separate signaling channel, such as a dedicated frequency sub-channel. Accordingly, a number of different signaling methods or structures may be utilized to indicate a new H-ARQ sequence.

In addition to indicating a new H-ARQ sequence, certain embodiments minimize the impact of detection error of a new H-ARQ sequence indicator. In some embodiments, the beginning of a new H-ARQ sequence is indicated by a signal that toggles between two indicators when the new H-ARQ sequence starts, while the signal remains the unchanged for retransmission of sub-packets in previous H-ARQ sequence. Each sub-packet of the same H-ARQ sequence is thus transmitted with an identical indicator. Upon beginning a new H-ARQ sequence, the indicator is toggled. In such embodiments, the receiver can detect the new H-ARQ indicator by determining if the indicator used in a subsequent sub-packet is different from the indicator used in a previous packet transmission.

Referring again to FIG. 1, in step 105 the receiver determines if a new H-ARQ sequence has been indicated. If an indicator of a new H-ARQ sequence was received, the H-ARQ buffer is flushed at the receiver in step 107. Otherwise, the data sub-packet stored in the buffer is soft-combined with the data sub-packet currently received. Regardless of whether the buffer is flushed, at step 109 data is detected in the sub-packet. Detecting data in the sub-packet may include the step of descrambling the sub-packet, or a portion thereof. After detecting data 109, step 111 is a cyclic redundancy check (CRC), comparing the CRC value transmitted within the packet itself, in a header of the sub-packet, or in an alternative signaling channel with a value computed from the data detected in the sub-packet. If the CRC fails, the process moves to step 115 adding the failed sub-packet to the detection buffer. As described previously, the detection buffer allows subsequent retransmitted sub-packets to be combined with failed sub-packets, enhancing the likelihood of constructing an accurate sub-packet. After adding the failed sub-packet to the detection buffer 115, a NACK is performed, which may take the form of an OFF, or non-transmission, to the transmitter.

If the CRC passes in step 111, the receiver performs an ACK in step 113, an acknowledgement to a transmitter that the packet was received correctly. An ACK generally entails a signal transmitted from the receiver to the transmitter on a return channel. When a transmitter fails to receive an ACK for a particular sub-packet, the transmitter will continue to resend the unacknowledged sub-packet. This process repeats for a finite number of attempted transmissions, the number of attempts based on the particular application. After sending the ACK in step 113, the process restarts, with the receiver again waiting for a new sub-packet at step 103.

The indicator used to transmit the new H-ARQ sequence, or one of the H-ARQ indicators, may utilize the second row of a fourth order Walsh matrix, i.e. W₁⁴ or “0101”. The other indicator may utilize the fourth row of the Walsh matrix, i.e. W₃⁴ or “0110”, used for the other indicator. Only two Walsh codes are used to indicate the new H-ARQ sequence; therefore, the remaining two Walsh codes may be used to multiplex other information, such as transmit ID in a CDM fashion.

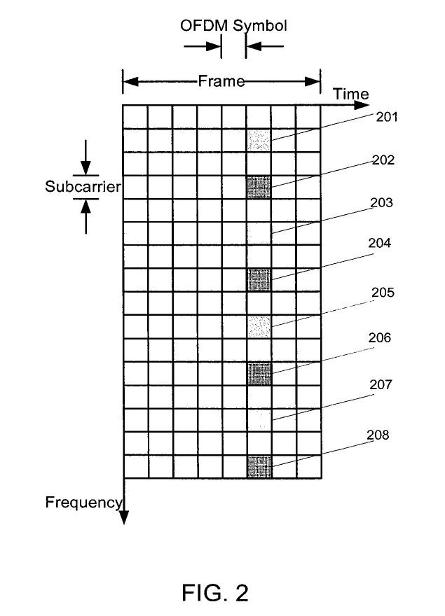

Referring now to FIG. 2, an example of a resource assignment is provided according to the present invention. In the embodiment illustrated, eight distributed sub-carriers (201, 202, 203, 204, 205, 206, 207, and 208) are assigned. Four sub-carriers (202, 204, 206, and 208) are used to transmit the new H-ARQ indicator while the other four sub-carriers (201, 203, 205, and 207) are used to transmit data. This particular example also shows that the header of the sub-packet consists solely of the new H-ARQ indicator. Moreover, the four bits of this encoded indicator (header) are distributed within the assigned resource, in order to take advantage of frequency diversity. The modulation format of the new H-ARQ indicator is also independent of resource assignments, and may use Binary Phase Shift Keying (BPSK), for example. Other modulations and configurations may also be utilized, and are comprehended hereby.

In other embodiments of the present invention, output power used to transmit the H-ARQ indicator (the header part of the sub-packet) may be significantly increased over that of the data part of the sub-packet. In such embodiments, the reliability of the new H-ARQ indicator may be ensured by transmitting at that higher power.

According to the present invention, some embodiments of the present invention may utilize signaling of the sharing format. In some embodiments, the use of the format is implied by a preferential (or “sticky”) assignment, therefore all transmissions in response to the sticky assignment use the sharing format described herein. As a result, all users sharing radio resources are assigned a sticky assignment. However, in other embodiments of the present invention, the sharing format may be signaled in the assignment message. In such embodiments, the users sharing the resources with the user having the sticky assignment are not necessarily assigned with sticky assignments themselves. Numerous other signaling methods may be utilized to indicate the sharing format used without diverging from the spirit of the present invention.

In other embodiments of the present invention, packet processing information—such as multiple encoder packet sizes, or modulation and coding scheme (MCS) for a data segment—may be indicated in associated with a particular resource assignment. In such embodiments, modulation for a resource assignment may be fixed, and may be explicitly indicated or signaled in the resource assignment. In another embodiment, the MCS may be dynamically changing and may be explicitly signal via a message in a separate channel. In yet another embodiment, the MCS may be implicitly signal with the receiver blindly detecting the MCS. In addition, an encoder packet size may be different. Rate matching by either puncturing or repetition may be used to match the rate to resources assigned for different encoder packet sizes. The number of different encoder packet sizes associated with a particular resource assignment is small, and a receiver can blind detect among them. For example, with a VoIP user where the vocoder can send full rate, ½ rate, ¼ rate and ⅛ rate frames, repetition is used with the lower rate frames in order to make all frames full rate. The receiver may blindly detect among the different rates. In another embodiment, the encoder packet size may be explicitly indicated or signaled to a receiver in the header section or as an explicit message in a separate channel.

With respect to the ACK (acknowledgment) and NACK (no acknowledgement) responses for the H-ARQ process, the ACK and NACK utilize on-off keying, the NACK being represented by OFF (no transmission) and the ACK being represented by ON. In this way, the processing at the receiver is the same for all users. Users will generally always respond with a NACK when the received data is not intended for them. Consequently a plurality of unintended users can respond with a NACK using the same allocated resources without collision as no transmission actually occurs. This permits intended users to utilize shared radio resources, signaling an ACK without collision. This particular method of signaling the ACK and NACK will save resources, but other methods of transmitting the ACK and NACK responses may be utilized with the present invention.

In accordance with other aspects of the present invention, a sub-packet index may be explicitly transmitted in a sub-packet header segment. In certain embodiments, the presence of a first sub-packet index in a header segment of the first sub-packet indicates a first sub-packet transmission. It also indicates to a receiver that a transmission of a new packet has begun. Meanwhile the presence of any other sub-packet index indicates a subsequent sub-packet for a retransmission of a previously failed packet.

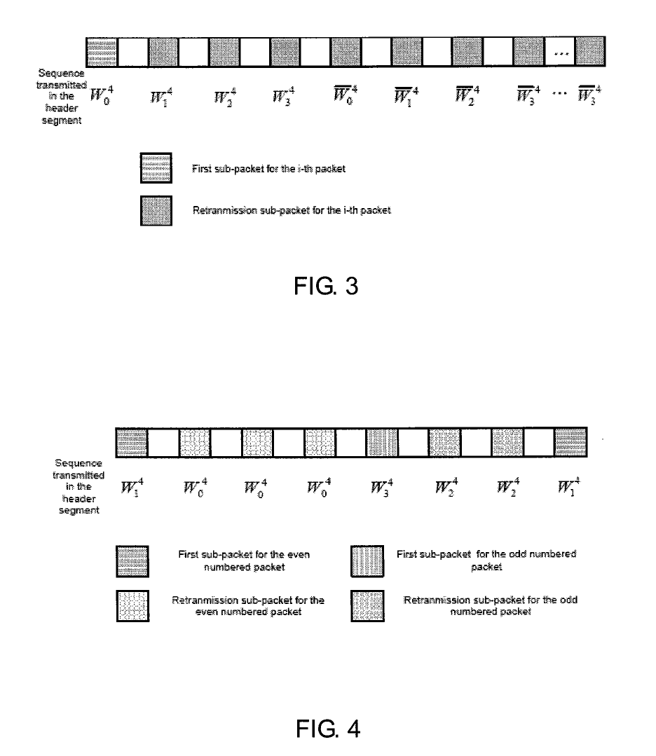

In the example depicted in FIG. 3, 4-ary Walsh codes are used as the sequences to indicate the sub-packet indices. The first Walsh code, W₀⁴, is used to indicate a first sub-packet transmission. The second Walsh code, W₁⁴, indicates a second sub-packet transmission. The third Walsh code, W₂⁴, indicates a third sub-packet transmission, and so on. For minimizing overhead, only a first “n” number of sub-packets need to be explicitly signaled, while other sub-packet transmissions may be signaled with a continuation signal. As shown in FIG. 3, a 4-ary Walsh code can be used to signal a first 8 sub-packet transmission, using both the Walsh code and its complement. For subsequent sub-packet transmissions, a complement of the fourth Walsh code, W̅₃⁴, may be utilized as a continuation indicator.

In certain embodiments, indication of a new packet transmission comprises a toggle between two mutually exclusive subsets of the Walsh codes. As illustrated in the example in FIG. 4, first and second 4-ary Walsh codes, W₀⁴ and W₁⁴, form a first subset, and third and fourth 4-ary Walsh codes, W₂⁴ and W₃⁴, form a second subset. In this embodiment, a first sub-packet transmission is indicated by Walsh code W₁⁴ or W₃⁴ in a header segment. For example, W₁⁴ may be used to indicate a first transmission of the i^{th} packet. W₀⁴ may then be used to indicate all subsequent transmissions of the i^{th} packet. With a first transmission of the (i+1)^{th} packet, W₃⁴ may be used to indicate transmission of the first sub-packet. Furthermore, since W₃⁴ is in the second subset of Walsh codes, while W₀⁴ and W₁⁴ are in the first subset of Walsh codes, W₃⁴ in a header segment of the first sub-packet also indicates that a new packet transmission has started. Subsequent transmission of the (i+1)^{th} packet may be indicated by W₂⁴. With a first transmission of the (i+2)^{th} packet, W₀⁴ may once again be used as an indicator, and so on.

Thus, one Walsh code in the first subset of Walsh codes may be used to indicate a new, even numbered packet transmission has started. Remaining Walsh codes in the first subset of Walsh codes may be used to indicate subsequent retransmissions of the even numbered packet transmission. In a similar fashion, one Walsh code in the second subset of Walsh codes may be used to indicate a new, odd numbered packet transmission has started. The remaining Walsh codes in the second subset of Walsh codes may be used to indicate subsequent retransmissions of the odd numbered packet transmission. Other methods of indicating beginning of transmission of a packet, and the packet number, may be employed. For example, an explicit sub-packet number may be carried in a header segment.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of sharing radio resources in an OFDMA communication system, having a transmitter and a first and a second receiver, comprising the steps of:
providing a plurality of assignable radio resources;
designating a unique scrambling code for each receiver;
providing a packet;
defining a plurality of sub-packets for the packet;
selecting one of either the first or the second receivers to receive the packet on a first assignable radio resource; and
performing a scrambling process on the plurality of sub-packets, utilizing the respective scrambling code of the selected one of either the first or the second receivers, at the transmitter.

2. The method of claim 1, wherein the transmitter assigns the first assignable radio resource in a persistent manner to the first receiver.

3. The method of claim 2, wherein the transmitter further assigns the first assignable radio resource in a persistent manner to the second receiver.

4. The method of claim 2, wherein the transmitter further assigns the first assignable radio resource in a non-persistent manner to the second receiver.

5. The method of claim 2, further comprising the steps of:
performing a descrambling process at each receiver with a respective unique scrambling code;
performing a decoding process at each receiver;
performing a cyclic redundancy check at each receiver;
sending an acknowledgment from a receiver if its cyclic redundancy check is positive; and
sending a negative acknowledgment from a receiver if its cyclic redundancy check is negative.

6. The method of claim 5, wherein an acknowledgment is sent explicitly with ON keying, and a negative acknowledgment is sent implicitly with OFF keying.

7. The method of claim 5, further comprising the steps of:
providing a notification from the transmitter to a receiver of transmission of a new packet;
providing a detection buffer at the receiver;
clearing the detection buffer, before decoding a packet, if a notification of transmission of a new packet is detected at the receiver;
soft-combining a currently descrambled sub-packet with descrambled sub-packets stored in the detection buffer, before decoding a packet, if a notification of transmission of a new packet is not detected at the receiver; and
storing combined sub-packets in the detection buffer if cyclic redundancy check is negative.

8. The method of claim 7, wherein notification of transmission of a new packet further comprises transmitting an indicating signal, on a signaling channel separate from a channel carrying the packets.

9. The method of claim 7, wherein notification of transmission of a new packet further comprises providing an indicating signal in a header of each sub-packet.

10. The method of claim 7, wherein the transmitter uses Walsh codes to provide notification of transmission of a new packet.

11. The method of claim 10, wherein notification of transmission of a new packet further comprises signaling a toggle between a first Walsh code and a second Walsh code.

12. The method of claim 11, wherein the transmitter further communicates information explicitly to a receiver using Walsh codes other than the first or second Walsh codes.

13. The method of claim 12, wherein the information comprises a modulation and coding scheme.

14. The method of claim 12, wherein the information comprises encoder packet size.

15. The method of claim 12, wherein the information comprises a sub-packet index.

16. A method of processing sub-packets at a receiver, having an H-ARQ detection buffer, in an OFDMA communication system, comprising the steps of:
receiving a sub-packet;
descrambling the sub-packet using a unique scrambling code associated with the receiver;
soft-combining a currently descrambled sub-packet with descrambled sub-packets already stored in the detection buffer;
decoding a packet with the combined descrambled sub-packets;
performing a cyclic redundancy check; and
storing the combined sub-packets in the detection buffer if the cyclic redundancy check is negative.

17. The method of claim 16, further comprising the steps of:
detecting a new H-ARQ sequence; and
clearing the detection buffer, before the step of soft-combining, when a new H-ARQ sequence is detected.

18. The method of claim 17, wherein detecting a new H-ARQ sequence further comprises receiving an indicating signal on a signaling channel separate from the packet and sub-packets.

19. The method of claim 17, wherein detecting a new H-ARQ sequence further comprises including an indicating signal in a header of each sub-packet.

20. The method of claim 17, wherein detecting a new H-ARQ sequence further comprises identifying a toggle between a first indicator code and a second indicator code.

21. The method of claim 17, further comprising the step of sending an acknowledgment if the cyclic redundancy check is positive.

22. The method of claim 17, further comprising the step of sending a negative acknowledgment if the cyclic redundancy check is negative.

23. A system for sharing radio resources in an OFDMA communication system comprising:
a transmitter for transmitting a plurality of sub-packets, grouped as a packet, on a first radio resource;
a first and a second receiver for receiving the plurality of sub-packets from the transmitter on the first radio resource;
wherein the transmitter scrambles a sub-packet from the plurality of sub-packets with a unique scrambling code associated with either the first or the second receiver; and
wherein each receiver descrambles a sub-packet from the plurality of sub-packets with its respective unique scrambling code.

24. The system of claim 23 wherein each receiver performs a cyclic redundancy check to verify validity of a sub-packet.

25. The system of claim 24 wherein each receiver checks a header of the sub-packet to determine if the sub-packet is addressed to the first receiver.

26. The system of claim 24 wherein each receiver checks an explicit indicator in another channel to determine if a sub-packet is addressed to the first receiver.

27. The system of claim 23 wherein each receiver communicates an acknowledgment if its cyclic redundancy check is positive, or a negative acknowledgment if its cyclic redundancy check is negative.

28. A method for signaling an intended user of a packet in a multi-user communication system, comprising the steps of:
providing a persistent assignment of a first radio resource to a first user;
providing a packet to be transmitted to a second user using the first radio resource;
providing an indicator that a sub-packet of the packet is addressed to the second user;
transmitting the sub-packet to the first and second users; and
processing the sub-packet by the first and second users.

29. The method of claim 28, wherein the step of providing an indicator that a sub-packet of the packet is addressed to a second user is performed with an implicit method of signaling.

30. The method of claim 29, wherein the implicit method of signaling further comprises scrambling the sub-packet with a unique scrambling code associated with the second user.

31. The method of claim 28, wherein the step of providing an indicator that a sub-packet of the packet is addressed to a second user is performed with an explicit method of signaling the same.

32. The method of claim 31 wherein the explicit method of signaling further comprises embedding, within a header of the sub-packet, an explicit instruction that the sub-packet of the packet is addressed to the second user.

33. The method of claim 31 wherein the explicit method of signaling further comprises indicating, on a separate signaling channel, an explicit instruction that the sub-packet of the packet is addressed to the second user.
